(19) United States
(12) Patent Application Publication
(10) Pub. No.: US 2025/0220799 A1
(43) Pub. Date: Jul. 3, 2025

(54) DETERMINATION OF OPERATIONAL STATE OF X-RAY SOURCE

(71) Applicant: Excillum AB, Kista (SE)

(72) Inventors: Andrii Sofiienko, Kista (SE); Björn Hansson, Kista (SE)

(21) Appl. No.: 18/852,080

(22) PCT Filed: Mar. 28, 2023
(86) PCT No.: PCT/EP2023/057948

§ 371 Date: Sep. 27, 2024

(30) Foreign Application Priority Data
Mar. 29, 2022 (EP) 22164932.0

(51) Int. Cl. H05G 1/26; H05G 1/30

(52) U.S. Cl. CPC H05G 1/265; H05G 1/30

(57) ABSTRACT

A method at an X-ray source is disclosed, the X-ray source comprising an electron source for providing an electron beam and a target comprising a first working region for generating X-ray radiation upon interaction with the electron beam. The method comprises determining a first quantity indicative of a current absorbed by the target at the first working region, and in response to the first quantity deviating from an expected value moving the electron beam from the first working region to a reference region, determining a second quantity indicative of a current absorbed at the reference region, and determining an operational state of the X-ray source based on the first quantity and the second quantity, wherein the operational state is an electron beam fault state or a target fault state.

### TECHNICAL FIELD

The present disclosure relates to an X-ray source and a method at an X-ray source.

### BACKGROUND

X-ray radiation may be generated by an X-ray source in which an electron beam impacts upon a working region on a target. The performance of the X-ray source depends inter alia on the characteristics of the working region as well as the interaction between the electron beam and the target. Conventionally, only a portion of the energy of the impinging electron beam is transformed into X-ray radiation. The target is therefore often exposed to a relatively high thermal load, leading to thermally induced wear and a gradually reduced performance.

It is therefore of interest to monitor the performance of the target. This may for instance be done in a regularly performed calibration process, in which the electron beam is scanned over the surface of the target to generate an image of the surface of the target to detect visible defects. Alternatively, the X-ray radiation generated during the scanning is monitored to determine the performance at various locations on the target and to identify damaged regions.

Eventually, a damaged or malfunctioning target must be replaced. As this tends to be a relatively time-consuming process which often requires the X-ray source to be opened and taken out of operation, there is a need for a technology that reduces the time for maintenance and increases the uptime of the X-ray source.

### SUMMARY

The present disclosure relates to an X-ray source and a method in which an operational state of the X-ray source is determined.

A typical X-ray source, for which the inventive principles disclosed herein may be applied, comprises an electron source for providing an electron beam and a target comprising a working region for generating X-ray radiation upon interaction with the electron beam.

According to an aspect of the invention, a first quantity indicative of a current absorbed by the target at the working region is determined. Should the first quantity deviate from an expected value, the electron beam is moved from the working region to a reference region. Here, a second quantity is determined, which is indicative of a current absorbed at the reference region. The first quantity and the second quantity may then be used for determining an operational state of the X-ray source.

More specifically, the first and second quantities are compared to a predetermined criterion, and if the quantities fulfil the criterion the operational state is determined to be an electron beam fault state. If, on the other hand, the first and second quantities do not fulfil the predetermined criterion, the operational state is determined to be a target fault state. It is preferred that a ratio between the first quantity and the second quantity is calculated, and that the ratio is compared with a reference range. If the calculated ratio is within the reference range then the predetermined criterion is fulfilled, and if the calculated ratio is outside the reference range then the predetermined criterion is not fulfilled. Alternatively, only the second quantity is compared with a reference range, and if the second quantity is outside the reference range then the predetermined criterion is fulfilled, while if the second quantity is within the reference range then the predetermined criterion is not fulfilled.

The present invention is based on the recognition that while a deviating target current absorbed at the working region may indicate that there is a problem with the working region, it cannot be excluded that the deviation has another cause, such as a malfunctioning electron beam. Replacing the target, or changing to another working region, would therefore be in vain, as the problem lies elsewhere. A merit of the invention is that by moving the electron beam to a reference region in response to a detected deviation in the first quantity, the performance of the electron beam can be verified before any actions are taken with regard to the allegedly malfunctioning or damaged working region. Should the second quantity deviate from an expected range, this may indicate that there is an issue with the electron beam rather than with the working region. The determined deviation may for example be caused by a malfunctioning electron source or poorly calibrated electron optics. Thus, the inventive concept provides a way of verifying that the detected deviation at the working region is not related to the electron beam, and that it is motivated to change to another working region on the target or to replace the entire target.

Moving the electron beam from the first working region to a reference region to determine the second quantity, and thus the operational state of the X-ray source, is generally associated with an interruption in the X-ray production. Consequently, each move of the electron beam from the first working region risks adding to the downtime of the X-ray source. Beneficially, the present invention allows for the X-ray source to be operated according to a scheme in which the electron beam is moved from the first working region to the reference region first when a deviation is detected. This is advantageous over operating schemes in which the electron beam is moved between the working region and a reference region on a periodic basis, irrespectively of whether the first quantity is deviating from the expected value or not, as such schemes would cause the X-ray production to be interrupted also in cases when it is not motivated by any observations. By moving the electron beam in response to a deviation in the first quantity, the number of moves of the electron beam to the reference region may be reduced and the uptime of the X-ray source hence increased.

By the term “quantity indicative of a current absorbed at the working/reference region” should be understood any quantity that is possible to measure or determine, either directly or indirectly, and which comprises information that can be used for determining or characterizing the current absorbed by the target (also referred to as “target current” or “absorbed current”). Examples of such quantities may include an amount of generated X-ray radiation, a number of electrons passing through the target or being absorbed by the target, and a number of secondary electrons or electrons being backscattered from the target. Further examples include heat generated in the target, light emitted from the target, e.g. due to cathodoluminescence, and electric charging of the target. The quantity may also refer to brightness of the generated X-ray radiation. The brightness may for instance be measured as photons per steradian per square millimeter at a specific power or normalized per Watt. Alternatively, or additionally, the quantity may relate to the bandwidth of the X-ray radiation, i.e., the flux distribution over the wavelength spectrum.

The first quantity may for example be determined using a sensor, such as a current sensor, arranged to measure a current absorbed by the target as the electron beam interacts with the working region. The quantity may also be determined using an X-ray sensor or a sensor configured to measure backscattered electrons, secondary electrons or electrons transmitted through the target. Indirect measures of the target current, for example relating to X-ray radiation or backscattering, may require additional information to be known, such as a ratio between the electron beam energy that is converted into X-ray radiation and the energy that is absorbed as target current, or the ratio between backscattered and absorbed electrons. This information may for instance be determined at the installation of the X-ray source, from calibration measurements, or as a constant associated with the specific target type. Further, it will be realized that the first quantity may be determined by monitoring a sequence of values over time, either continuously or discretely, to detect trends and deviations over time.

The second quantity may be determined in a similar way as the first quantity, preferably using the same sensor as for the first quantity. However, in case the reference region does not form part of the target as such, it may be advantageous to use a separate sensor dedicated to such a reference region. The reference region may for instance form part of a target holder or form a separate element which preferably may have a relatively high electron absorption.

Deviations in the first quantity may be determined in relation to an expected value or range. The expected value or range may for example be a reference value associated with the target type and/or settings by which the electron beam is operated. The reference value may hence be defined during an installation process or a previously performed calibration. In some embodiments, the expected value may be determined based on previous measurements, for example forming a sequence of measurements over time. Thus, a deviation may be defined as a gradual change in the monitored parameter, such as for instance a gradual decrease in generated X-ray radiation or gradual increase in absorbed target current, or a deviation from a previously recorded time average of the quantity. In some embodiments, a slow gradual decrease in said first quantity may be expected and also compensated for by increasing the emission current. A deviation may in this case be defined as an unexpected rate of change, such as a sudden drop from a steady decrease. Preferably, the first quantity is monitored during operation of the X-ray source to assess whether the target quality is consistent.

Should the first parameter be determined to deviate from the expected value, for instance by falling outside a predetermined range or vary at a rate exceeding a reference rate, the electron beam spot may be moved to the reference region. The electron beam may be moved to the reference location immediately when a deviation is detected, or operation may be continued despite the detected deviation and the electron beam moved to the reference location once there is a pause in the operation of the X-ray source. The reference region may form part of the target or be a separate element, structurally and physically distinct from the target. In an example, the reference region is another working region on the target, having known interaction characteristics with the electron beam. Hence, the working region and the reference region may be of a similar type and material. Alternatively, the working region may be a region suitable for generating X-ray radiation during operation of the X-ray source, whereas the reference region is selected as a region that is not involved in the generation of X-ray radiation during normal operation of the X-ray source. The reference region may preferably have a lower backscatter coefficient than the working region, such as for instance less than two thirds of the backscatter coefficient of the working region.

The target may for instance comprise a sheet, foil or substrate having at least two different regions that can be used as the working region and the reference region, respectively. The target may be formed of a patterned or etched material suitable for generation of X-ray radiation, wherein the removed portions, defining the pattern or geometrical structures, may form the reference region. The substrate may for instance be a diamond substrate covered with a patterned layer of tungsten, wherein the working region is arranged on the tungsten layer and the reference region is formed by the partly exposed, underlying diamond substrate.

The operational state of the X-ray source may for instance be a target fault state, in which a suspected malfunction or damage of the working region is indicated, or an electron beam fault state in which a suspected problem with the electron beam performance is indicated. In case of a target fault state, an operator may be prompted to select another working region, or to replace the target. The new working region may for instance be selected from a list of available working regions, either automatically by the X-ray source itself, manually by the operator, or semi-automatically by the operator being presented with one or more possible working regions. The first working region, for which the suspected malfunctioning or damage was determined, may then be indicated as not available in an updated version of the list.

In case of an electron beam fault state, the operator may be prompted to start troubleshooting or adjusting the electron beam settings. The operator may for example change to another electron beam generator, adjust or recalibrate the electron optics, or adjust the electron beam alignment. Further, a detected malfunctioning of the working region or electron beam may result in the operation of the X-ray source being discontinued and a warning or error signal being generated.

It will be appreciated that the above measures in response to a detected fault state in some options may be performed automatically, without the intervention of an operator, and in other options may involve actions performed by the operator.

In an embodiment, determining the operational state of the X-ray source, once a deviation in the first quantity has been detected, may comprise calculating a ratio between the first quantity and the second quantity and comparing the ratio with a reference range, which for instance may have been defined from previously performed measurements. The ratio may be measured as a part of a calibration procedure. An electron beam fault state may be indicated in response to the ratio being within the reference range. In case the ratio being outside the reference range, a target fault state may be indicated.

In another embodiment, the second quantity may be compared with a reference range, and an electron beam fault state indicated in case the second quantity lies outside the range and a target fault state indicated should the second quantity lie within the reference range.

Once it has been determined that the operational state is a target fault state, it is also envisaged to determine if the target fault state is caused by a depleted substrate or a depleted target layer. To this end, a third quantity indicative of a current absorbed by the target for a reduced acceleration voltage of the electron beam can be measured.

It will be appreciated that reference limits or thresholds may be considered instead of the above references ranges. The fault states may then be determined based on the ratio between the first and second quantities, or the second quantity as such, exceeding or being below such a reference limit or threshold.

As mentioned above the method may be implemented at an X-ray source comprising an electron source for providing an electron beam, and a target comprising a working region for generating X-ray radiation upon interaction with the electron beam. Thus, in another aspect of the invention there is provided an X-ray source comprising an electron optic arrangement for moving the electron beam on the target, a sensor arrangement for determining the quantity indicative of a current absorbed at the working region and the second quantity indicative of a current absorbed at the reference region, and a controller operatively connected to the electron source, the electron optic arrangement, and the sensor arrangement. The controller may be configured to compare the first quantity with an expected value, and in response to the first quantity deviating from the expected value, operate the electron optic arrangement to move the electron beam from the working region to the reference region. Further, the controller may determine an operational state of the X-ray source based on the first quantity and the second quantity.

The present invention contemplates different types of X-ray radiation generating targets. The target may, for example, comprise a reflection target or a transmission target. A target may further be provided as a stationary or moving (e.g., a rotating anode) target.

Several modifications and variations are possible within the scope of the invention, as defined in the appended claims. In particular, X-ray sources comprising more than one target, or more than one electron beam, are conceivable within the scope of the present inventive concept. The X-ray source may also comprise more than one electron source, such as an additional cathode that can replace the first one, should the latter be indicated as malfunctioning or defect. Furthermore, X-ray sources of the type described herein may advantageously be combined with X-ray optics and/or detectors tailored to specific applications exemplified by, but not limited to, medical diagnosis, non-destructive testing, lithography, crystal analysis, microscopy, materials science, microscopy surface physics, protein structure determination by X-ray diffraction, X-ray photo spectroscopy (XPS), critical dimension small angle X-ray scattering (CD-SAXS), wide-angle X-ray scattering (WAXS), and X-ray fluorescence (XRF).

### BRIEF DESCRIPTION OF DRAWINGS

The following detailed description will be presented with reference to the accompanying drawings, on which:

FIG. 1 schematically shows an X-ray source with parts and components relevant for this disclosure;

FIGS. 2a-c illustrate a target that comprising a working region and a reference region;

FIGS. 3a-c illustrate a damage to a working region of a target;

FIG. 4a is a diagram illustrating the relation between target thickness and electron backscatter probability;

FIG. 4b is a diagram illustrating the relation between target damage and absorbed target current;

FIG. 5 schematically outlines an X-ray source comprising a controller and a memory; and

FIG. 6 is a flowchart illustrating a procedure for identifying an operational state of the X-ray source.

### DETAILED DESCRIPTION

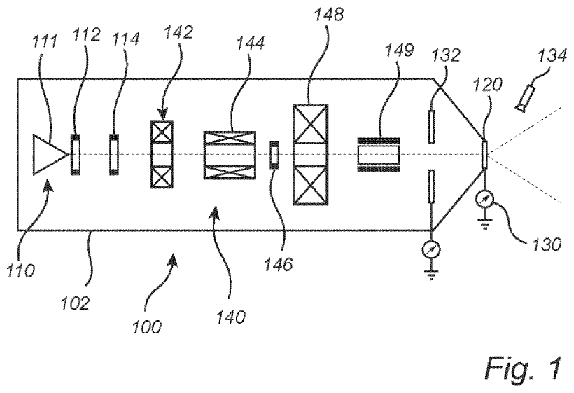

FIG. 1 shows an apparatus 100 for generating X-ray radiation, generally comprising an electron source 110 for providing an electron beam and a target 120 for generating X-ray radiation upon interaction with the electron beam. Further, an electron optic arrangement 140 may be provided for moving the electron beam spot on the target 120. In the present example, the electron source 110 comprises a cathode 111, a grid (also referred to as a Wehnelt) 112 and an anode 114 aligned along the optical axis of the electron optic arrangement 140. The cathode 111 is arranged to emit the electrons of the electron beam, which are accelerated towards the anode 114 by an acceleration potential. The Wehnelt 112 may be arranged to adjust the cone angle of the electron beam emitted by the cathode 111. The beam direction may be adjusted by the electron optic arrangement 140, which in the present example comprises a set of alignment coils 142 and two sets of stigmator coils 144 for adjusting the cross-sectional shape of the electron beam. Further, an aperture 146 may be arranged along the beam path to prevent unintended emissions at high angles from reaching the target 120. The electron optic arrangement 140 may also include a focusing lens 148 to provide the desired electron beam spot size, as well as a deflector 149 for moving the electron beam spot over the target 120. As mentioned above, the electron source 110 and the electron optic arrangement 140 may be arranged along an optical axis of the X-ray source and to direct the electron beam onto the target 120, which hence also may be arranged along the optical axis. Further, as illustrated in the present figure, the electron source 110 and the electron optic arrangement 140 may be arranged within a housing 102, which may define a sealed or actively pumped chamber protecting the electron beam path from the surrounding environment. The target 120 may function as an X-ray window of the housing 102, allowing the X-ray radiation to be emitted from the chamber. In other embodiments an X-ray window may be provided in the housing to allow emission of X-ray radiation.

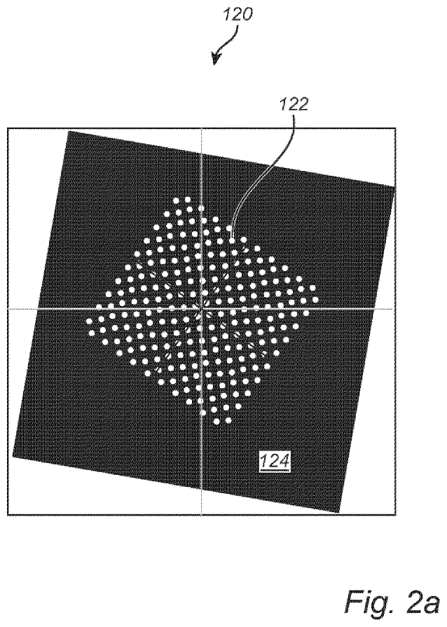

The X-ray source 100 may further comprise a sensor 130 for measuring a first quantity indicative of a current absorbed by the target 120 at a first working region of the target and, in some examples, a second quantity indicative of a current absorbed at the reference region (please refer to FIGS. 2a-c for more details regarding the working region and the reference region). In the present example the same sensor 130 may be arranged to measure both the first and second quantity. However, the second quantity may also be measured by another sensor, different from the sensor measuring the first quantity.

The sensor 130 shown in the present figure may for example be a current sensor arranged to measure a target current generated by electrons of the electron beam being absorbed by the target 120. The current sensor 130 may for example be electrically connected to the target 120 and in series with a lower potential, such as ground. The output from the current sensor 130 may hence be a direct reflection of the target current.

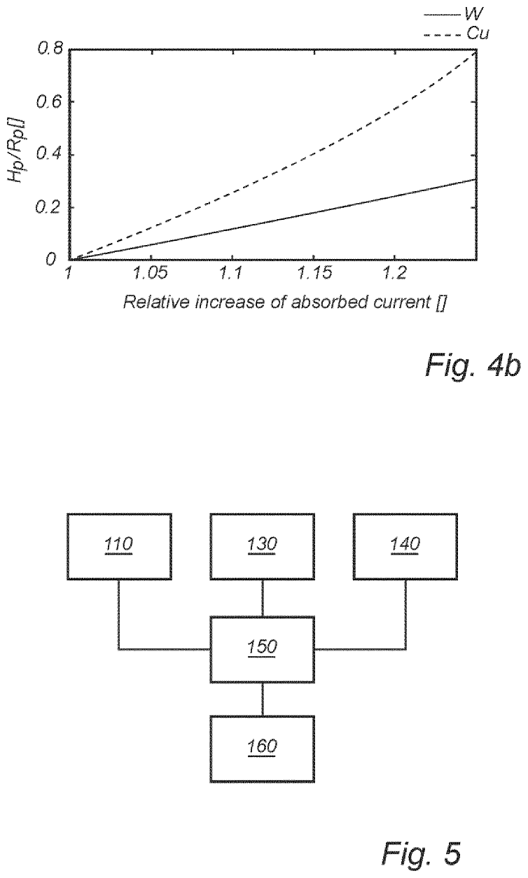

Other sensor arrangements are however also conceivable. In one option, the sensor may be configured to provide an indirect measure of the target current. This may for instance be achieved by measuring backscattered electrons or the generated X-ray radiation. FIG. 1 shows an example of a backscatter sensor 132 arranged upstream the target 120 (with reference to the electron beam path) to collect backscattered electrons. The backscatter sensor 132 may further comprise a current meter for measuring the absorbed current generated by the backscattered electrons. FIG. 1 also shows an example of an X-ray sensor 134 arranged to generate a signal indicative of a quality measure of the generated X-ray radiation, such as number of photons generated per second or the brilliance of the X-ray radiation. The output of the sensor(s) may be transmitted to a controller (shown in FIG. 5) configured to determine an operational state of the X-ray source based on the first and second quantity.

FIGS. 2a-c show an example of a target 120 according to some embodiments of the invention, wherein FIGS. 2a and 2b show a top view of the target 120 and FIG. 2c a cross section of the zoomed in portion of FIG. 2b. The target 120 may comprise a first region 121, or working region 121, suitable for producing X-ray radiation, and a reference region 122 suitable for verifying the performance of the electron beam. The working region 121 may preferably comprise a dense material like tungsten, which is known to generate X-ray radiation upon interaction with impinging electrons. The dense material may be provided in a layer 124 on a substrate 123, which may be formed of a material that compared to the material of the working region 121 is more transparent to impinging electrons. The substrate 123 may for instance comprise diamond or a similar light material with relatively low atomic number and preferably high thermal conductivity. The target layer 124 may be provided with apertures, such as square, octagon or circle shaped holes exposing the underlying substrate 123. These apertures may for instance be formed by means of photolithograph and etching of the target layer 124.

During operation, that is, production of X-ray radiation, the electron beam may be kept at a fixed location on the target 120. When adjusting electron beam properties, such as electron beam spot size, the electron beam may be scanned over the target 120 and in particular over edges separating parts of the target 120 provided with the X-ray generating material (such as tungsten) and parts where the underlying substrate (such as the diamond substrate) is exposed. Since the electron absorption coefficient may differ for these two regions, data from a target current sensor 130 shown in FIG. 1 may be used to create an image of the target 120. Furthermore, by measuring the change in absorbed target current as the electron beam is scanned over an edge between two regions, the electron beam spot size may be calculated.

FIGS. 2a and b show a top view of an exemplary target, wherein FIG. 2b is a zoomed in portion of the target 120. The target layer 124, which in the present example is formed of tungsten, may have a thickness in the order of 0.5 micrometers (μm) and the substrate 123, which for example may be formed of diamond, a thickness in the range of 100-400 μm, such as 100-150 μm.

The entire size of the patterned area or structured target shown in FIG. 2a may be 800×800 μm, and the electron beam spot size on the target may lie in the range of 100 nm to 20 μm, such as 300 nm to 1200 nm. The pattern of open regions may repeat itself every 60 μm. The pattern may comprise larger open regions 122 and smaller open regions 122′. The larger open regions may be used for measuring electron beam throughput, that is, the total current incident on the target for a particular setting of the electron optical arrangement. The electron beam throughput may be used for calculating the fraction of electron beam that passes through the aperture 146 and consequently a cone angle from the electron source 110. The cone angle may be adjusted by applying a bias potential on the grid 112 to either attract the electrons towards the grid 112 (making the cone angle wider) or repelling them from the grid 112 towards the beam center (making the cone angle narrower).

The smaller open regions 122′ may be referred to as calibration points 122′ used during a calibration procedure for adjusting parameters relating to for instance focus, astigmatism, and positioning of the electron beam.

The regions of the target layer 124 between open regions 122, 122′ may be used as working regions 121 for generating X-ray radiation during operation of the X-ray source. The working regions 121, which also may be referred to as operating points, may be defined by an operator indicating a suitable region, or be retrieved from a listing of possible working regions (or coordinates) on the target 120. In general, the working region 121 shown in FIG. 2b may be divided into sub-regions where each sub-region may be used as an operating point, provided that the quality of one sub-region is not affected by the usage of a neighboring sub-region as the active working point.

A first quantity indicative of the current absorbed by the target at a working region 121 may be monitored during X-ray generation. This may for example be achieved by means of a target current sensor 130 arranged to provide a direct measure of the target current, or a backscatter sensor 132 or an X-ray sensor 134 arrange to provide an indirect measure of the target current, as discussed above with reference to FIG. 1. If the target current is determined to be consistent during the X-ray radiation, or lying within a predetermined or expected range, the X-ray generation may proceed as planned. However, should the monitoring of the first quantity indicate a deviation from the expected value, for example by gradually changing over time or lying outside a predetermined range, a decision may be taken to investigate whether the change in current is caused by changes in the target 120 or by changes in the electron beam. The decision may be taken automatically by the system or be referred to an operator.

The investigation may involve moving the electron beam from the working region 121 to a reference region, preferably with known electron absorption properties. The reference region may for example be one of the larger open regions 122 discussed above, or another working region 121 on the target layer 124. A second quantity, indicative of the target current absorbed at the reference region, may be measured (preferably in a similar way as the first quantity) and used for determining an operational state of the X-ray source 100. The second quantity may for instance be compared with a reference value, such as an expected limit or range, or compared with the first quantity. In the latter case, a ratio between the first quantity and the second quantity may be calculated and compared with a reference range. If the ratio lies within the reference range, this indicates that there may be something wrong with the electron beam. If the ratio lies outside the reference range, this indicates that there may be something wrong with the working region 121. In the latter case the operator, or a controller of the X-ray source 100, may select another working region 121 and resume operation or decide to replace the target, should no more suitable working regions be available.

In case the reference region is an alternate working region 121 on the target layer 124, a difference in absorbed target current may be caused by different backscattering at the two regions. In case the generated X-ray radiation is measured as an indirect measure of the target current, a decrease in X-ray radiation at a first working region may trigger a move of the electron beam to a second working region, functioning as a reference region. If the generation of X-ray radiation is restored after the move to the second working region, this indicates a fault at the first working region and the operation may therefore continue at the second working region. If, on the other hand, the X-ray output (or absorbed target current) is not restored after the move to the second working region, this indicates that the deteriorating performance probably is not caused by the first working point being damaged or worn.

It will be appreciated that the inventive concept is not limited to transmission type targets. On the contrary, the concept of determining an operational state of an X-ray source based on a first quantity indicative of a target current absorbed at a working region and a second quantity indicative of a target current absorbed at a reference region may as well be implemented for other types of targets, such as reflection targets. The embodiments shown in FIGS. 1 and 2a-c are merely illustrative examples.

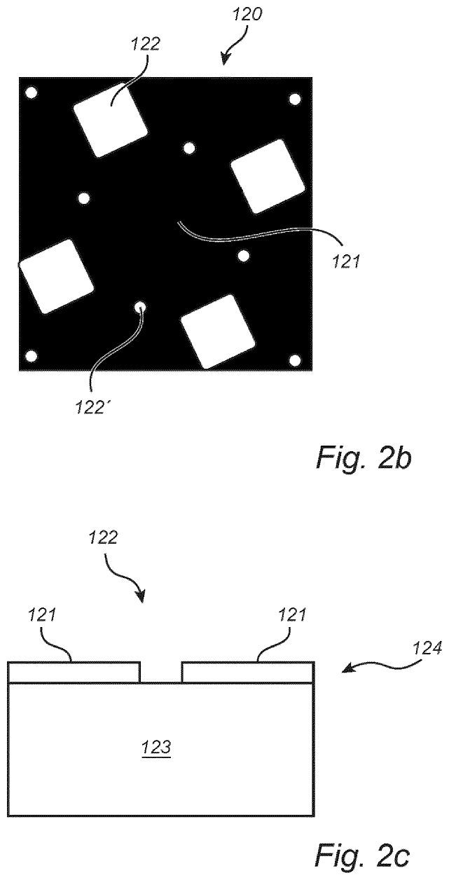

In the following, a detailed example of the relation between absorbed target current and backscattering of electrons will be discussed with reference to FIGS. 3a-c and 4a-b to elucidate a possible realization of the inventive concept. The discussion applies to an X-ray source and a target which may be similarly configured as the exemplary X-ray source 100 and target 120 discussed above with reference to FIGS. 1 and 2a-c. A theoretical model is proposed for determining the depth of a wear-induced damage in a working region 121, caused by the impinging electron beam, and its relation to absorbed target current.

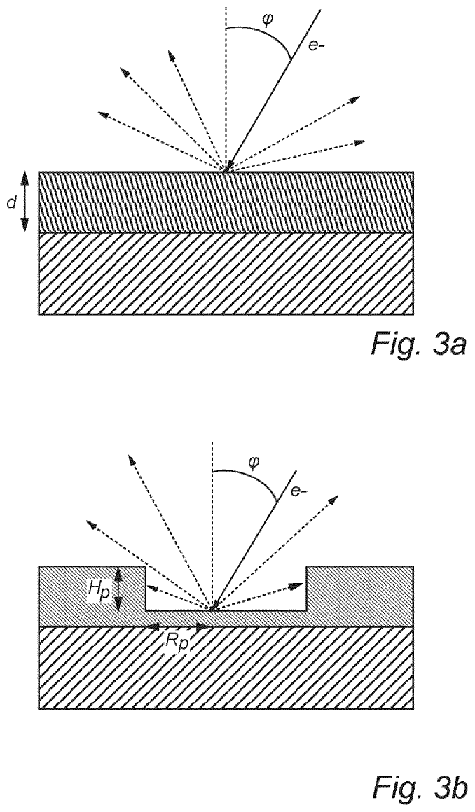

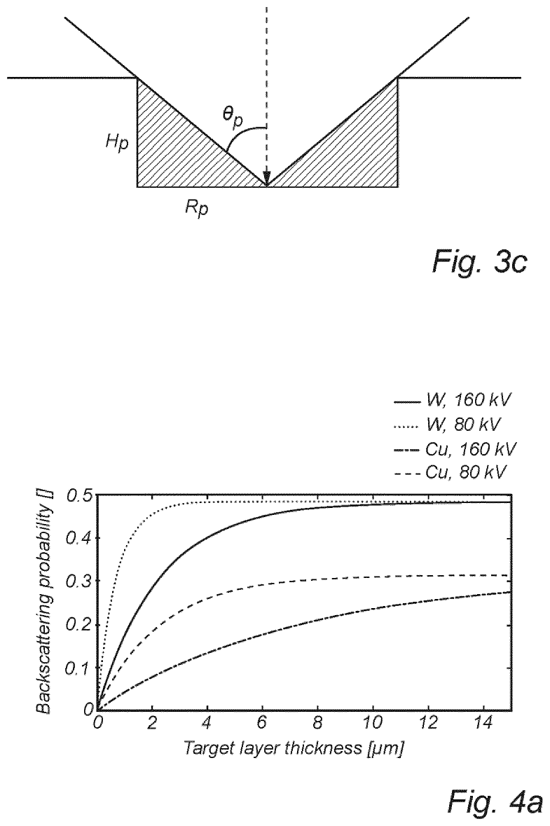

FIG. 3a illustrates an ideal working region, having a flat surface, whereas FIGS. 3b and c illustrate a wear-induced damage in the form of a recess or pit in the surface of the working region. The pit may be characterized by its depth Hₚ and effective radius Rₚ and the impinging electron beam by its incident angle φ relative a normal of the surface on which the electron beam impinges. Further, the backscattered electrons may be defined by the solid angle θₚ in FIG. 3c, within which backscattered electrons may escape the target. Hence, FIG. 3c illustrates two different regions: a first one defining electron trajectories of electrons scattering out of the pit, and a second one defining trajectories of electrons scattering from the bottom of the pit and being absorbed by the pit walls. Furthermore, FIG. 4a illustrates the backscattering probability as a function of target thickness for tungsten and copper at 160 kV and 80 kV acceleration voltage. FIG. 4b shows the relation between target damage and relative increase in absorbed current for thick tungsten and copper targets for 160 kV acceleration voltage.

The backscattering probability (BP) of high energy electrons is known to depend on electron energy (E), the chemical composition (atomic number Z) and the incident angle of the electron beam (φ) as well as the geometry of the target. If an electron beam interacts with a flat target comprising a recess, or pit, the solid angle for backscattered electrons is less than 2π and part of the electrons may therefore be absorbed in the pit, as illustrated in FIGS. 3b and c. The increase of the absorbed current (AC) depends, inter alia, on the depth Hₚ and effective radius Rₚ of the pit. The absorbed current may be computed as the difference between the oncoming electron beam current and the current of scattered and not measured electrons outside of the pit solid angle:

$${i}_{a b s} = {i}_{b e a m} \cdot ( 1 - {η}_{B} ( Z , φ , E ) \cdot ( 1 - {η}_{a} ) ) , \qquad ( 1 )$$

where l_{abs} is the measured AC, i_{beam} is the oncoming electron beam current, η_{B} (Z, φ, E) is the backscattering probability for the electrons for (π/2−φ) incident angle between the target surface and electron beam and ηₐ is the probability for electron absorption within the pit. In a general case some of the backscattered electrons may be absorbed by surrounding parts of the system in such way as to contribute the measured absorbed current. In this case equation (1) would need to be modified. The probability no depends on the pit configuration and can be estimated as follows:

$${η}_{a} = {ξ}_{p} \frac{Δ {Ω}_{p}}{2 π} , \qquad ( 2 )$$

where ζₚ is the fraction of oncoming electrons reaching the pit and ΔΩₚ is the solid angle within which backscattered electrons interact with the pit walls and so can be absorbed within the pit. An analytical expression for the solid angle ΔΩₚ can be written as:

$$Δ {Ω}_{P} ( {H}_{p} , {R}_{p} ) = 2 π - {\int }_{0}^{2 π} d {φ}^{′} {\int }_{0}^{θ ( {H}_{p} , {R}_{p} )} sin ( θ ) d θ , \qquad ( 3 )$$

$$Δ {Ω}_{P} ( {H}_{p} , {R}_{p} ) = 2 π \cdot cos ( \frac{π}{2} - arc tg ( \frac{{H}_{p}}{{R}_{p}} ) ) = 2 π \cdot sin ( arc tg ( \frac{{H}_{p}}{{R}_{p}} ) ) . \qquad ( 4 )$$

$${η}_{a} = {ξ}_{p} \cdot sin ( arc tg ( \frac{{H}_{p}}{{R}_{p}} ) ) , \qquad ( 5 )$$

where θₚ (Hₚ, Rₚ)=π/2-arctg [Hₚ/Rₚ] is the angle defined by the height of the pit, Hₚ, and the effective pit radius, Rₚ. A simplified schematic of the solid angle computation for the case of normal incidence of incoming electrons to the target surface is shown in FIG. 3c.
Equation (5) can be written as follows:

$${η}_{a} = {ξ}_{p} \cdot \frac{1}{\sqrt{1 + {( \frac{{R}_{p}}{{H}_{p}} )}^{2}}} , \qquad ( 6 )$$

Equations (1) and (6) give the dependence of the relative increase of the absorbed current, ξₐ on the ratio of effective pit radius to pit height as follows provided the backscattering probability ns may be considered unaffected by the pit:

$${ξ}_{a} = \frac{{i}_{abs} ( {H}_{P} > 0 )}{{i}_{abs} ( {H}_{P} = 0 )} = 1 + \frac{{ξ}_{p} \cdot \frac{1}{\sqrt{1 + {( \frac{{R}_{p}}{{H}_{p}} )}^{2}}}}{\frac{1}{{η}_{B} ( Z , φ , E )} - 1} , \qquad ( 7 )$$

The inverse solution for the ratio of pit height to effective pit radius vs. the relative increase of the absorbed current allows us to estimate this ratio based on the experimentally measured change in absorbed current as follows:

$$\frac{{H}_{P}}{{R}_{P}} = \frac{1}{{( \frac{{ξ}_{p}}{( {ξ}_{a} - 1 ) ( \frac{1}{{η}_{B} ( Z , φ , E} - 1 )} )}^{2} - 1} . \qquad ( 8 )$$

where ξₐ is the measured value.

A simplified analytical solution for the backscattering probability in accordance with the illustration shown in FIGS. 3a and 3b may be written as:

$${η}_{B} ( Z , φ , E ) = {( 1 + cos φ )}^{- \frac{9}{\sqrt{Z}}} \cdot ( 1 - {e}^{- ( \frac{0.7 \cdot {Z}^{0.66 {7}_{d - {H}_{P}}}}{{R}_{e} ( Z , E ) cos φ} )} ) , \qquad ( 9 )$$

$${R}_{e} ( Z , E ) = 2.76 \cdot {10}^{- 10} \cdot \frac{A \cdot {E}^{1.67}}{ρ \cdot {Z}^{0.89}} \qquad ( 10 )$$

where φ is the angle between the electron beam and normal to the target, Rₑ is the electron penetration depth in meters (neglecting relativistic corrections) in the material with atomic number Z when electrons have the energy E eV, A is the atomic weight of the target material and ρ is the density in kg/m³. Some examples of computed backscattering probabilities as a function of target thickness for different electron energies and target materials are shown in FIG. 4a. An underlying assumption for equation (9) is that any target substrate makes negligible contributions to the probability for backscattering of electrons. This assumption will be justified for cases where the backscatter probability for the target layer is close to the value for bulk material and for cases when the backscatter probability for the substrate material is small in relation to the corresponding probability for the target material.

Equation (8) allows to track the dynamic damages on the target in situ during the normal operation of X-ray systems by measuring of the relative change of AC. The computed dependences (8) for thick (30 μm) copper and tungsten targets are shown in FIG. 4b. As seen from FIG. 4a, for a large enough layer thickness the backscatter probability is independent of electron energy as well as target layer thickness. Thus, data for FIG. 4b were calculated with an electron energy of 160 keV, repeating the calculations with 80 keV would result in virtually identical curves. For these calculations a fraction of incoming electrons interacting with the pit, ξ_{ρ}=0.9 was assumed.

The radius of the pit can be found by making an assumption of which physical process is dominant. For example, if evaporation of the metal target is the dominant process then the radius of the evaporated pit can be estimated roughly as follows:

$${( {R}_{P} )}_{e v aporation} \approx 2 \cdot {C}_{target} \cdot \sqrt{{σ}_{x T} \cdot {σ}_{y T}} , \qquad ( 11 )$$

where C_{target} is a constant that depends on the target material (C_{cu}≈0.435), σ_{xT} and σ_{yT} are the standard deviations of the temperature field distribution within the electron spot (we assume that the elliptical electron spot is oriented along the X axis). Thus, from equations (8) and (11) an observed relative change in the absorbed current may be used to calculate an effective pit radius and a pit height.

In an exemplary embodiment the target comprises a thick, such as at least 30 μm, copper layer. In this case equation (9) gives a correct estimate for the backscattering probability and may be used in equation (8) to correlate a relative change in absorbed target current to target damage. If a relative increase in absorbed current above a predetermined limit, such as 5%, is detected the electron beam spot may be moved to some other location on the target known to be undamaged. If the absorbed current at this location is restored to, or at least close to, the initial value recorded at the previous site the X-ray systems operational state may be set to indicate a target fault state. If, on the other hand, the absorbed current is not restored the operational state may be set to indicate an electron beam fault state. Furthermore, monitoring the absorbed target current provides a way to monitor target damage in terms of pit depth and radius by use of equation (8) and (11) above. Note that equation (7) was derived under the assumption that the backscatter probability is not affected by the target damage so the change in absorbed current is due to absorption in the pit walls. This assumption is justified for a 30 μm thick copper layer as can be seen from equations (9) and (10), at least for reasonably small pit depths.

In another exemplary embodiment the target comprises a 0.5 μm thick tungsten layer on top of a 150 μm thick diamond substrate. Parts of the tungsten layer has been removed to expose the diamond substrate as shown in FIGS. 2a-c. The electron acceleration voltage is set to 160 kV and the electron beam is arranged to impact the target perpendicularly to the target surface. From equation (10) the electron penetration depth in diamond may be calculated as about 17 μm. Since the thickness of 150 μm is much bigger than the penetration depth the exponential in equation (9) may be neglected and the backscatter probability for the substrate may be considered equal to that of bulk diamond, i.e. the pre-factor in equation (9) which equals about 7.8% for diamond. This is a sensible design choice since electrons escaping from the target to the ambient atmosphere will cause ozone creation. The 0.5 μm thick tungsten layer is however quite far from bulk properties as seen from FIG. 4a. To calculate the resulting backscatter probability for the electrons impacting on the tungsten layer the following expression may be used:

$${η}_{e f f} = {η}_{s} + {η}_{B} \cdot ( 1 - \frac{{η}_{s}}{{η}_{B 0}} ) ) \qquad ( 12 )$$

where ηₛ is the backscattering probability for the diamond substrate, η_{B0} is the bulk backscattering probability for the target layer material (48.4% for tungsten), and η_{B} is the backscattering probability for the target layer according to equation (9). Thus for 0.5 μm of tungsten, which by itself would have a backscatter probability of about 9.6%, on top of a diamond substrate the effective backscattering probability is about 16%. Thus, the backscatter coefficient of the exposed substrate is about 49% of the backscatter coefficient at the target layer. The corresponding absorbed target current when the electron beam is directed to a working point on the tungsten layer is about 84% of the beam current (since substantially all electrons not backscattered will be absorbed by the target), whereas directing the electron beam to a reference region where the diamond substrate is exposed the absorbed current is about 92.2% of the beam current. Consequently, the expected ratio between the absorbed currents measured at the working point and the reference region respectively is about 0.91 (84/92.2). Note that for this configuration equation (7) above may not be valid since the backscatter probability will decrease when target material evaporates. Thus, to make quantitative estimates on the target damage a more elaborate model needs to be applied in this case. If a virgin part of the tungsten layer is used as a reference, rather than an exposed (i.e. bare, uncovered) portion of the substrate, the expected ratio between the two measurements is one. In case target material has evaporated from the working point the absorbed current at that location will be larger than the absorbed current measured at a virgin part of the tungsten layer, since a thinner target layer will cause less backscatter and thereby larger electron absorption in the substrate.

As seen from equation (10) above, the electron penetration depth is dependent on the electron energy. Thus, by adjusting the acceleration voltage different depths of the target may be probed by measuring the absorbed or backscattered current. Electrons subjected to a comparatively low acceleration voltage may interact mainly with material close to the target surface whereas electrons subjected to a comparatively high acceleration voltage will interact with material deeper into the target. Modulation of the acceleration voltage may thus be used as a tool to further investigate the type of target damage that may have occurred. This enables a more detailed operational state to be determined.

An example of a target fault state is that contamination, e.g. hydrocarbons, have deposited on top of the target layer. The hydrocarbon layer, comprised of elements with comparatively low atomic numbers, will have a lower backscatter probability than the target material. This will be particularly evident for lower electron energies. High energy electrons may penetrate the hydrocarbon layer. A consequence of this is that for this type of target damage one may expect a characteristic dependence of the absorbed current upon the acceleration voltage. For comparatively low electron energies the majority of electron will be absorbed within the hydrocarbon layer giving a comparatively high absorbed current. For higher energies the electrons will penetrate the hydrocarbon layer and backscatter from the tungsten layer, thus decreasing the absorbed current. As the energy increases further electrons will penetrate the tungsten layer and be absorbed in the diamond layer, thus leading to an increase in the absorbed current. For even higher energies the electrons will start to escape through the diamond substrate and thus the absorbed current will decrease. In other words, by observing the voltage dependence of the absorbed current a more detailed operational state may be determined. If data from target current monitoring indicates that a hydrocarbon layer is building up on the target the operator may be prompted to check on any pumping system configured and arranged to control the atmosphere within the X-ray source enclosure.

One way to differentiate between the two types of target damage that lead to an increase in absorbed target current may be to measure the absorbed current, or a quantity dependent on the absorbed current, at a comparatively low acceleration voltage, say of the order of a few kV. For the case of a depleted target layer the absorbed current will decrease as compared to that measured at working conditions. This is because at lower energies fewer electrons will penetrate the target layer and the backscattering probability will approach the bulk value for the target material. For higher energies more electrons will penetrate the target layer and thus backscattering probability will go down. On the other hand, if an observed increase in absorbed current at the operating voltage is caused by hydrocarbon contamination on top of the target layer a further increase is expected at low voltages. The reason being that for low energies fewer electrons will penetrate the contamination layer and instead be absorbed. The hydrocarbon layer having low atomic number as compared to the target layer will have a lower backscattering probability as seen from equation (9) above.

The two types of target damage discussed above (target layer evaporation and hydrocarbon build-up) both result in an increased absorption current. However, if a decrease in absorbed current is observed and a reference measurement confirms that a target fault state should be indicated, another type of target damage may be inferred. A thinner substrate layer beneath the working position may be a reason behind such observation. This may happen due to evaporation or oxidation of the substrate from the outside. Should this operational state be indicated, the operator may be prompted to ensure proper cooling of the target.

To summarize, three different target fault states may be identified according to the invention: a depletion of the target layer, buildup of contaminations on top of the target layer, and depletion of the substrate. In case a target fault state is identified a new working position may be selected to prolong operation of the X-ray source. Furthermore, the operator may be prompted to perform maintenance on different parts of the X-ray source depending on which target fault state that has been indicated. Depletion of the target layer may be avoided by lowering the power or the power density applied to the target. Buildup of contaminations may be mitigated by plasma cleaning. Depletion of the target substrate may be prevented by improving the cooling of the target or by decreasing the power or the power density applied to the target.

FIG. 5 is a schematic representation of a system, or an X-ray source, which may be similarly configured as the X-ray source 100 discussed in connection with FIGS. 1 and 2a-c. As shown in the present figure, a controller 150 may be provided for controlling the operation of the electron source 110 and/or the electron optic arrangement 140. The controller 150 may further be communicatively connected to a sensor 130, such as a target current sensor, a backscatter sensor or an X-ray sensor delivering data to the controller which are indicative of the current absorbed by the target. The controller may be configured to perform the method outlined in the embodiments above by determining a deviation in the first quantity from an expected value, causing the electron optic arrangement 140 to move the electron beam spot to a reference region on the target, and determining a second quantity indicative of a current absorbed at the reference region using data from the sensor 130. The expected values may for instance be based on a previously recorded time average of the measured quantity, which may be retrieved from a memory 160 communicatively connected to the controller. The memory 160 may further store and maintain a list of working regions 121, from which a second working region may be selected in response to the operational state of the X-ray source indicating a target fault state. Preferably, the controller 150 updates the list of working regions regularly to keep track of which working regions that are still available and which ones that are “consumed”, i.e., determined to be malfunctioning or damaged.

In some embodiments, the controller 150 may be operatively connected to a user interface configured to present information indicating a fault, such as a target fault or an electron beam fault. The presented information may instruct an operator to select another working region, change the target, adjust the electron beam settings, or change to another electron source, depending on the determined operational state of the X-ray source and the available working regions. In an example, the operator may be presented a list of available, alternative working regions.

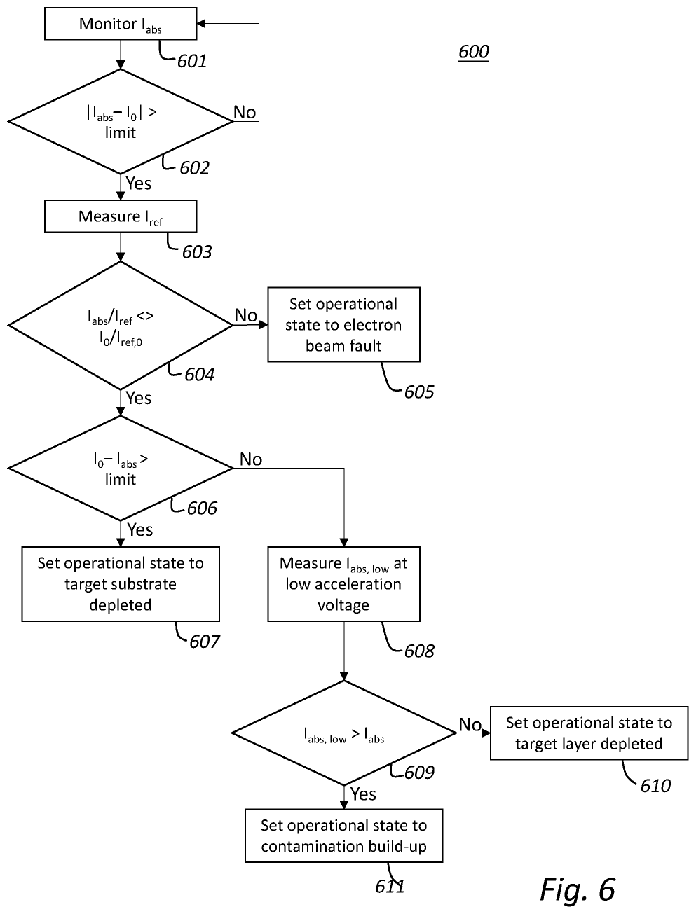

An example of a method 600 according to the invention is illustrated in FIG. 6. The absorbed target current (l_{abs}) at the working point, or a quantity indicative of the absorbed target current, is monitored during operation, as indicated at step 601. The monitored absorbed target current is then compared to an expected value (l₀) and if the magnitude of the difference exceeds a preset limit, it is determined that there is a deviation from the expected value, as indicated at step 602. If a deviation from the expected value (l₀) is detected the electron beam is moved to the reference location where the absorbed reference current (l_{ref}), or a quantity indicative of the absorbed current, is measured at step 603. A comparison is then made between on the one hand the ratio between the absorbed current (l_{abs}) and the reference current (l_{ref}) and on the other hand between the expected current value (l₀) and the expected reference current value (l_{ref, 0}) at step 604. If the ratio between the absorbed current and the reference current is sufficiently close to an expected ratio, the reason for change in absorbed target current may be attributed to a change in the incoming electron beam and the operational state be set to an electron beam fault state, as indicated at step 605. If, on the other hand, the ratio l_{abs}/l_{ref} deviates from the expected ratio, a target fault state may be inferred. The method may then continue to infer the type of target fault state. At step 606, the observed target current l_{abs} is compared to the expected current value l₀ and if the difference exceeds a preset limit it is inferred that the target substrate is depleted, as indicated at step 607. If the observed target current is less than the expected value it means that electrons are escaping from the target and the operational state may thus be set to target substrate depletion. If the absorbed target current is instead larger than the expected value, the reason can be either depletion of the target layer or build-up of contaminations on top of the target layer. To differentiate between these two cases the absorbed current at a reduced acceleration voltage may be measured, as indicated at step 608. A determination is then made, at step 609, whether the absorbed current at the reduced acceleration voltage is larger than the absorbed current at the non-reduced acceleration voltage. If the absorbed current decreases when the acceleration voltage is lowered it means that more electrons are backscattered which indicates that the electron beam impacts on the target layer. Thus, the operational state may be set to target layer depleted, as indicated at step 610. If on the other hand the absorbed current increases for reduced acceleration voltages it means that a material with low backscatter probability is present at the surface of the target layer and hence the operational state may be set to contamination build-up, as indicated at step 611.

There may also be an extreme case of target layer depletion corresponding to evaporation of the entire thickness of the target layer at the working position. In this case the absorbed current will increase when the voltage is lowered. This state may be recognized from the fact that the absorbed current will be equal to that seen with the electron beam directed to a reference location, where the substrate is exposed, for all acceleration voltages. In this case the operational state may be set to a target layer evaporated state. By continuous monitoring of the absorbed target current and having a sufficiently strong criterion to investigate a potential target damage, complete evaporation of the target layer may be avoided.

The invention claimed is:

1. A method at an X-ray source comprising:
an electron source for providing an electron beam, and
a target comprising a first working region for generating X-ray radiation upon interaction with the electron beam;
wherein the method comprises, by means of a controller:
determining a first quantity indicative of a current absorbed by the target at the first working region;
in response to the first quantity deviating from an expected value:
moving the electron beam from the first working region to a reference region;
determining a second quantity indicative of a current absorbed at the reference region; and
determining an operational state of the X-ray source based on the first quantity and the second quantity;
wherein the operational state is an electron beam fault state if the first quantity and the second quantity fulfil a predetermined criterion; and
wherein the operational state is a target fault state if the first quantity and the second quantity do not fulfil the predetermined criterion.

2. The method according to claim 1, wherein the first quantity and the second quantity are determined based on output from a current sensor.

3. The method according to claim 1, wherein the expected value is a previously recorded time average of the first quantity.

4. The method according to claim 1, wherein determining the operational state of the X-ray source comprises:
calculating a ratio between the first quantity and the second quantity;
comparing the ratio with a reference range;
wherein the predetermined criterion is fulfilled if the ratio is within the reference range; and
wherein the predetermined criterion is not fulfilled if the ratio is outside the reference range.

5. The method according to claim 1, wherein determining the operational state of the X-ray source comprises:
comparing the second quantity with a reference range;
wherein the predetermined criterion is fulfilled if the second quantity is outside the reference range; and
wherein the predetermined criterion is not fulfilled if the second quantity is within the reference range.

6. The method according to claim 1, wherein indicating the target fault state is followed by directing the electron beam onto a second working region for generating X-ray radiation upon interaction with the electron beam, the second working region being different from the first working region.

7. The method according to claim 6, wherein the second working region corresponds to the reference location.

8. The method according to claim 1, further comprising selecting the reference region from a list of working regions.

9. The method according to claim 8, further comprising indicating the first working region as not available in the list.

10. The method according to claim 1, further comprising selecting the reference region as a region arranged on the target.

11. The method according to claim 1 wherein the operational state is a target fault state, the method further comprising:
setting the operational state to a target substrate depleted state if the first quantity deviates from the expected value in correspondence with a decrease of the current absorbed by the target;
measuring a third quantity if the first quantity deviates from the expected value in correspondence with a decrease of the current absorbed by the target, wherein the third quantity is indicative of a current absorbed by the target for a reduced acceleration voltage;
setting the operational state to a target layer depleted state if the third quantity is smaller than the first quantity; and
setting the operational state to a contamination build up state if the third quantity is larger than the first quantity.

12. The method of claim 11 wherein the reference region corresponds to a region where the target substrate is exposed further comprising:
measuring a fourth quantity indicative of a current absorbed at the reference region for the reduced acceleration voltage; and
setting the operational state to a target layer evaporated state if the first quantity is equal to the second quantity and the third quantity is equal to the fourth quantity.

13. An X-ray source comprising:
an electron source for providing an electron beam;
a target comprising a working region for generating X-ray radiation upon interaction with the electron beam;
an electron optic arrangement for moving the electron beam on the target;
a sensor arrangement for determining a first quantity indicative of a current absorbed at the working region and a second quantity indicative of a current absorbed at a reference region; and
a controller operatively connected to the electron source, the electron optic arrangement, and the sensor arrangement;
wherein the controller is configured to:
compare the first quantity with an expected value;
in response to the first quantity deviating from the expected value, operate the electron optic arrangement to move the electron beam from the working region to the reference region; and
determine an operational state of the X-ray source based on the first quantity and the second quantity;
wherein the operational state is an electron beam fault state if the first quantity and the second quantity fulfil a predetermined criterion; and
wherein the operational state is a target fault state if the first quantity and the second quantity do not fulfil the predetermined criterion.

14. The X-ray source according to claim 13, wherein:
the target comprises a substrate and a target layer arranged on the substrate;
the working region is formed of a portion of the target layer; and
the reference region is formed of an exposed portion of the substrate.

15. The X-ray source according to claim 13, wherein a backscatter coefficient of the reference region is less than two thirds of a backscatter coefficient of the working region.

16. The X-ray source according to claim 13, wherein the sensor arrangement comprises at least one of a current sensor and an X-ray sensor.

17. The X-ray source according to claim 13, wherein the target is a transmission target or a reflection target.
